(19) United States
(12) Patent Application Publication
(10) Pub. No.: US 2010/0032057 A1
(43) Pub. Date: Feb. 11, 2010

(54) PORTABLE PIPE THREADING FUNNEL AND METHOD OF MANUFACTURING THE SAME

(76) Inventor: Harvey Multer, Hollis, ME (US)

Correspondence Address: KEVIN FARRELL;PIERCE ATWOOD, ONE NEW HAMPSHIRE AVENUE, PORTSMOUTH, NH, 03801, US

(21) Appl. No.: 12/187,520

(22) Filed: Aug. 7, 2008

(51) Int. Cl. B67C 11/04; B65B 39/00

(52) U.S. Cl. 141/337; 141/340

(57) ABSTRACT

In one embodiment, the present invention comprises a pipe threading machine comprising a cutter, a reamer and a threader. The pipe threading machine further comprises a releasably attached funnel. One embodiment of the funnel comprises angled sidewalls joined to form a leak proof funnel shaped receptacle, a continuous upper rim disposed about the upper opening of the leak proof funnel shaped receptacle, and a drain hole located at the bottom of one or more angled sidewalls. The funnel further comprises a connection arm extending from the funnel and adapted for mating with the pipe threading machine such that the leak proof funnel shaped receptacle suspends upright. A drain pipe extends from the drain hole for redirecting fluid draining from the pipe threading machine into a fluid repository. The funnel optionally comprises a horizontal stabilizing latch extending from the upper rim.

### BACKGROUND OF THE INVENTION

1. Field of the Invention

The present invention relates generally to the field of pipe threading machines. More particularly, this invention relates to a novel pipe threading machine comprising a threader and a detachable oil funnel that is adapted for suspension from the pipe threading machine for recapturing reusable fluids.

2. Discussion of Background Information

Portable pipe threading machines, such as the RIDGID 300 and REED 5301PD, require continuous application of oil to the cutting dies, reamer and/or pipe cutting attachment during use. Typically, pipe threading machines perform three main operations that produce a finished product: (1) pipe cutting, (2) pipe reaming and (3) pipe threading. The first operation requires cutting the pipe to length with a cutting attachment on the pipe threading machine. The second operation involves reaming the end of the pipe with the machine's reamer to remove burrs and insure a consistent opening. The third operation comprises running the pipe through the threading die on the pipe threading machine.

A machine operator uses an oiler to apply thread cutting oil to the pipe during each operation. Typically, the oiler comprises a round tub with an approximately 20 inch diameter and a colander like basket disposed therein for separating any metal pipe shavings from the reusable oil dripping from the pipe threading machine. The oiler is placed beneath the work area of the pipe threading machine with the intent of catching all dripping oil. Typically, a hose extends from the bottom of the oiler to a hand pump dispenser so that the machine operator may reuse the recaptured oil dripping from the dies, reamer and/or cutter and re-dispense the oil as needed during each step of the threading operation.

Oilers typically are insufficient for capturing all oil and metal shavings exiting portable threading machines. Because they rest on floor or ground three feet below the threading die, reamer and cutter, typical oiler receptacles are insufficient for thoroughly gathering all cast off material jettisons by the moving machinery parts. This insufficient recapture results in an oily mess on the floor or ground around the oiler and pipe threading machine comprised of sharp metal shavings from the threaded pipe and cast off cutting oil. This mess requires proper cleaning which wastes valuable time and, if executed incorrectly, may result in potential harm to the environment. Additionally, discarded cutting oil translates to a monetary loss.

A need therefore exists for a pipe threading machine comprising a cutter, a reamer, a threader and an easily manufactured, lightweight durable funnel that suspends beneath the cutter, reamer, and threader and captures all reusable cutting oil and discarded metal shavings in order to prevent unnecessary expense and cleanup commonly associated with portable pipe threading operations.

### SUMMARY OF THE INVENTION

The present invention is directed to a pipe threading machine comprising a cutter, a reamer and a threader assembled on a base portion. The pipe threading machine further comprises a portable funnel attached thereto. One embodiment of the portable funnel comprises a body portion comprising one or more angled sidewalls joined to form a leak proof funnel shaped receptacle, a continuous upper rim disposed about the upper opening of the leak proof funnel shaped receptacle, and a drain hole located at the bottom of the one or more angled sidewalls. The portable funnel further comprises a connection arm extending from the body portion and adapted for mating with the base portion such that the leak proof funnel shaped receptacle suspends upright beneath the cutter, reamer and threader. A drain pipe extends from the drain hole for redirecting fluid draining from the cutter, reamer and threader into a fluid repository. The portable funnel optionally comprises a stabilizing latch extending from the upper rim and oriented for engaging a support surface of the base portion. In one embodiment, the leak proof funnel shaped receptacle comprises four angled sidewalls. In another embodiment, the leak proof funnel shaped receptacle comprises a singular, continuous angled sidewall formed in the shape of a cone.

The present invention also is directed to a method of manufacturing a pipe threading machine. One embodiment of the method comprises assembling a base portion comprising a threader, a cutter and a reamer and attaching a funnel to the base portion beneath the threader, cutter, and reamer. In one embodiment the funnel comprises a body portion comprising one or more angled sidewalls joined to form a leak proof funnel shaped receptacle, a continuous upper rim disposed about the upper opening of the leak proof funnel shaped receptacle, and a drain hole located at the bottom of the one or more angled sidewalls. The funnel further comprises a connection arm connected by a support structure extending from the body portion, wherein the connection arm is adapted for mating with the base portion and suspending the leak proof funnel shaped receptacle in an upright position. One embodiment of the funnel further comprises a drain pipe extending from the drain hole for redirecting fluid draining from the threader, cutter and reamer into a fluid repository.

### BRIEF DESCRIPTION OF THE DRAWINGS

FIG. 1 is a front view of a typical portable pipe threading machine.

FIG. 2 is a front view of a typical portable pipe threading machine with an embodiment of the present invention attached.

FIG. 3 is a close up side view of a typical portable pipe threading machine with an embodiment of the present invention attached.

FIG. 4 is a perspective top view of an embodiment of the present invention.

FIG. 5 is a perspective bottom view of an embodiment of the present invention.

FIG. 6 is a perspective side view of an embodiment of the present invention.

### DETAILED DESCRIPTION

The present invention resolves the stated deficiencies of pipe threading operations. Various features and advantages of the present invention are described below with reference to preferred embodiments and variations thereof. Those skilled in the art, however, will understand that alternative embodiments of the structures and methods illustrated herein may be employed without departing from the scope and principles of the described invention.

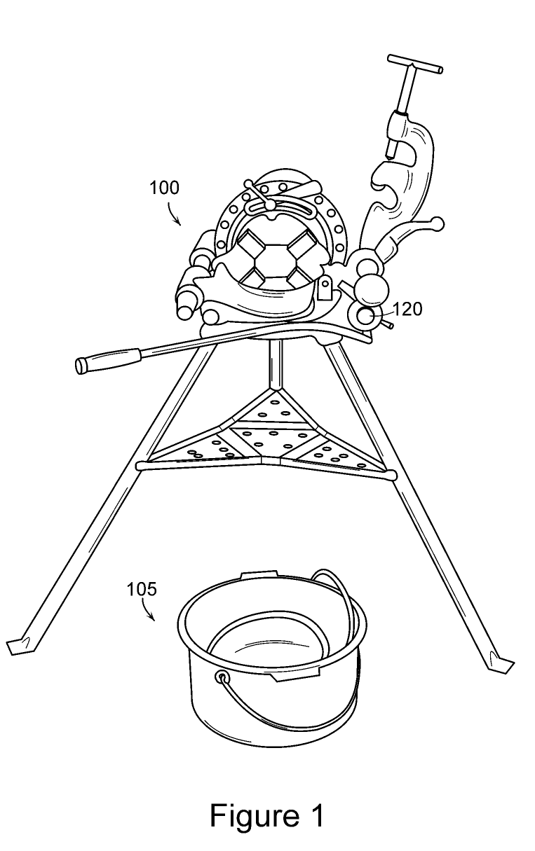

FIG. 1 shows a front end view of a typical portable pipe threading machine 100 that cuts, reams and threads pipes. A typical oiler 105 rests beneath the pipe threading machine 100 for catching and recirculating cutting oil dripping from the cutter, reamer and threading tools. As the instruments rotate and cut, oil drips and splatters from the pipe threading machine 100 in a non-uniform pattern that often extends beyond the bounds of the oiler 105, leaving oil and metal shavings from a threaded pipe discarded about the ground or floor around the oiler 105.

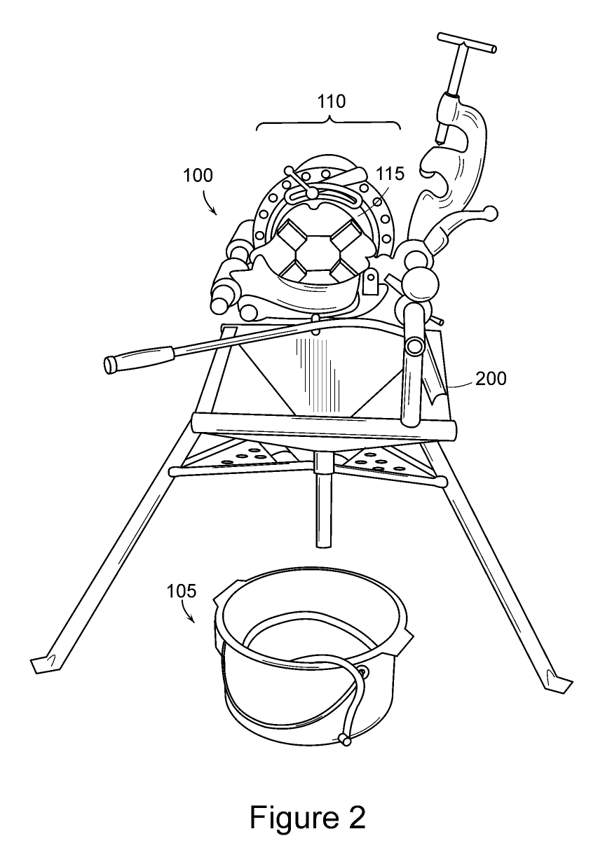

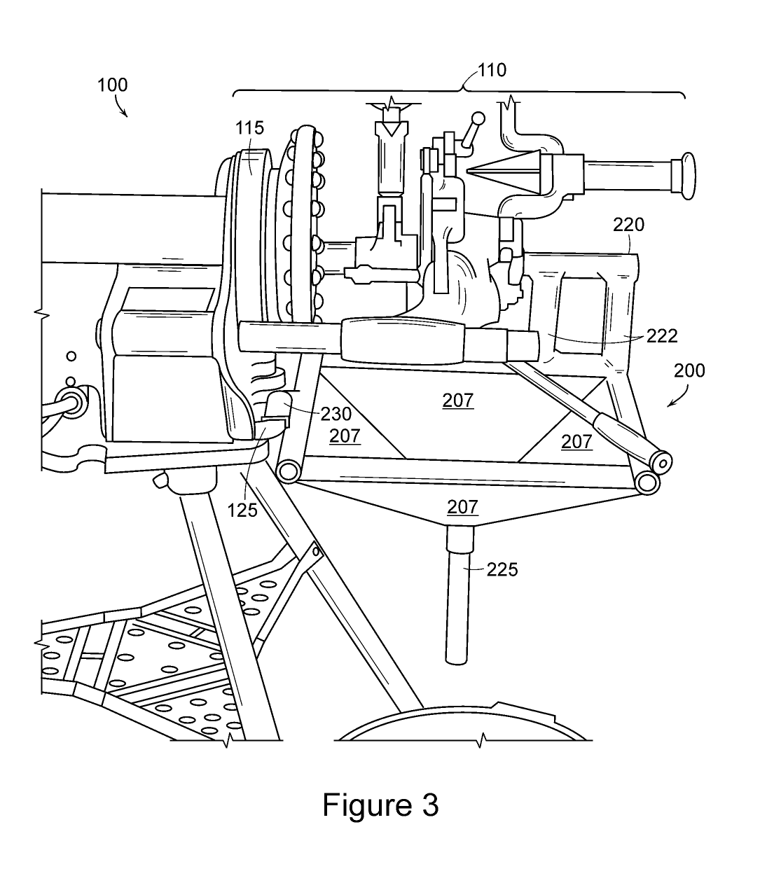

As FIGS. 2 and 3 depict, the present invention is a funnel 200 designed to hang from the threading machine 100 and accurately and thoroughly catch and redirect metal shavings and dripping cutting oil exiting the threading machine 100. As will be further described in relation to particular design elements, the funnel 200 successfully directs cutting oil into the oiler 105 or other fluid repository for recirculation to components of the pipe threading machine 100. As FIGS. 2 and 3 clearly show, the funnel 200 mounts closely to a base portion work area 110 from which shavings and cutting oil fall from one or more of a cut pipe, a cutter, a reamer attachment and a threading die. In preferred embodiments, the funnel 200 hangs less than a foot below the base portion work area 110 and more preferably hangs six inches or fewer beneath the base portion work area 110. Additionally, the funnel 200 is sufficiently wide so as to extend fully beneath the work area components to deflect all shavings into the funnel 200 and prevent them from landing on the ground. In preferred embodiments, the funnel 200 thereby extends under the pipe cutter, threading die and reaming attachment and catches oil or other reusable fluid dripping from those components even when they are unused and retracted to their storage positions. In embodiment of FIGS. 2 and 3, the funnel 200 also extends under the bottom of a chuck 115 that clamps the pipe so that any cutting oil splattering onto the chuck 115 will ultimately drip down into the funnel 200.

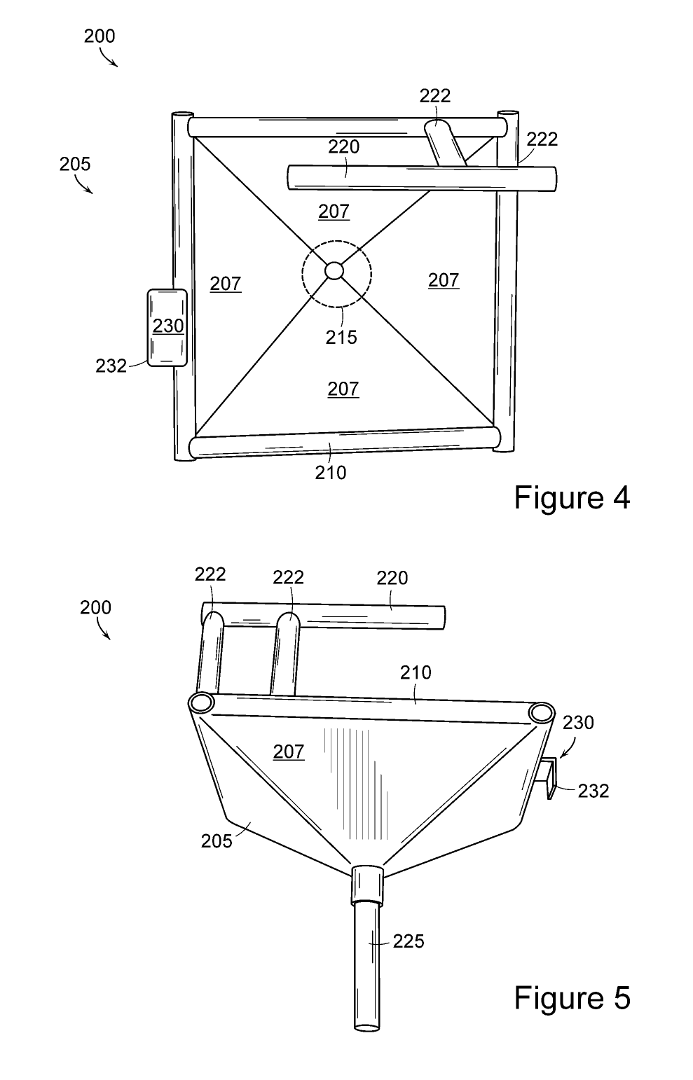

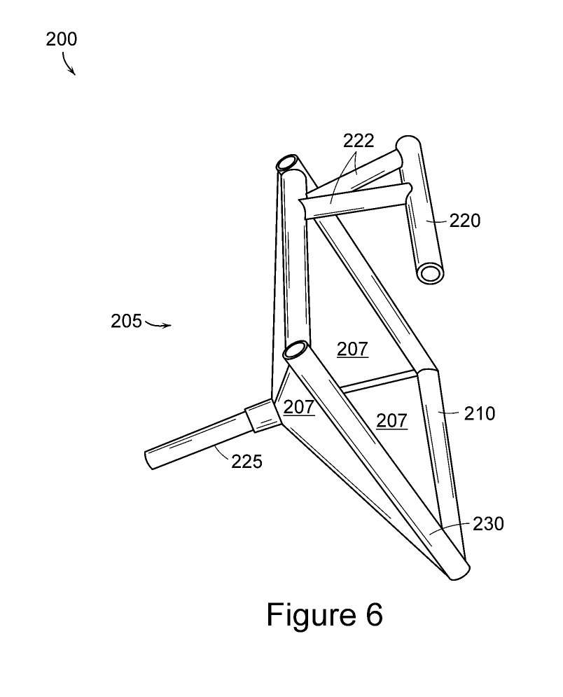

Turning now to the particular design elements of the funnel 200, FIGS. 4 through 6 depict one embodiment of the present invention. In one embodiment, the funnel 200 comprises a leak proof body portion 205 comprising one or more sloped sidewalls 207. In the embodiment of FIGS. 4 through 6, the funnel 200 comprises four sloped sidewalls 207 forming a square-shaped upper opening having a continuous, leak proof rim 210. The body portion 205 further comprises a drain hole 215 positioned at the bottom of the intersection of the one or more sloped sidewalls 207 so that the captured oil and metal shavings may drain from the funnel 200. In another embodiment, the funnel 200 may comprise a single sloped side wall 207 forming a round conical shape having a continuous, leak proof rim 210 around the larger, upper circumference and a drain hole 215 at the smaller, lower circumference of the conical funnel 200. In preferred embodiments, the one or more sloped sidewalls 207 are sloped at an angle between 30 degrees and 45 degrees so that the funnel 200 simultaneously is wide enough to capture debris and oil and steep enough to enable more viscous fluids to drain quickly to the oiler 105 or other fluid receptacle for recapture and reuse. Additionally, in some embodiments, the interior surfaces of the sloped sidewalls 207 further comprise a non-stick coating that assists with drainage and funnel cleaning.

A connection arm 220 extends from the the body portion 205 for engaging the base portion work area 110 and enabling the funnel 200 to suspend beneath the lubricated base portion work area 110. In one embodiment, the connection arm 220 extends from the leak proof rim 210. The connection arm 220, however, may extend from any portion of the funnel 200, such as the body portion 205. Some embodiments of the funnel 200 may comprise releasably attachable connection arms 220 for selective placement along the body portion 205 to enable setting the funnel 200 at various heights in relation to the base portion work area 110. For example, the connection arm 220 may selectively engage a track (not shown) on the outer surface of the body portion 205 through a spring loaded lock pin fastening system. During instances of high speed rotation of moving, oiled parts of the pipe threading machine 100, a user may prefer to adjust the funnel 200 closer to the work area 110 to capture high velocity splatters that may otherwise land outside the periphery of the rim 210. The connection arm 220 therefore preferably would engage the body portion 205 closer to the drain hole 215 so that the rim 210 would lie closer to the moving parts of the pipe threading machine 100.

In the embodiment of FIGS. 4 through 6, the connection arm 220 is oriented horizontally in relation to the floor such that the funnel 200 remains upright when engaged with the base portion work area 110. Any tipping may prevent thorough capture of lubricant and metal shavings emitted from the base portion work area 110. In some instances, an angled connection arm 220, however, may be preferable. Angling the connection arm from horizontal would angle the drain hole 215 and drain pipe 225 attached thereto so that fluid and debris would divert to an oiler 105 or other fluid receptacle positioned at a location near the work area 110, but not vertically beneath the same. This could be helpful in instances when the ground surface directly beneath the funnel 200 prevents secure and/or level placement of oiler 105 or other fluid receptacle. In the embodiment of FIGS. 4 through 6, the connection arm 220 is generally cylindrical and resembles a pipe such that the connection arm 220 may be securely inserted within an existing orifice of the base portion work area 110 such as the pipe hollow 120 depicted in FIG. 1. The connection arm 220 may be sized for a particular manufacturer's base portion work area 110 and may be releasably attached to the rim 210 and/or body portion 205 and thereby interchangeable with other configurations of connection arms 220 dimensioned for mating with particular features of base portion work areas 110.

In the embodiment of FIGS. 2, through 6, the connection arm 220 attaches to the rim 210 by a support structure 222. In this embodiment, the support structure 222 comprises two connection members, each rising at unique angles from separate portions of the rim 210 for added stability and support. As described above, in some embodiments, the connection arm 220 may be releasably attached to the rim 210 and/or body portion 205, and the support structure 222 may connect to the rim 210, body portion 205, and/or connection arm 220 via a releasable fastening means, such as but not limited to a snap fit, lock pin, or clamp. In other embodiments, the support structure 222 maybe hingedly attached to either or both of the connection arm 220 and rim 210 and/or body portion 205. Embodiments of the funnel 200 comprising such hinged attachment enable fine adjustments to compensate for any tipping of the funnel 200 and/or to intentionally tip the funnel 200 during instances when a parabolic flow trajectory of fluid and debris is desirable to reach an oiler 105 or other fluid receptacle located in a spot other than directly beneath the pipe threading machine 100. In the embodiment of FIGS. 2 through 6, the support structure 222 comprises permanently welded pipe portions.

The connection arm 220 is of sufficient length so as to ensure proper balance and secure support of the funnel 200. Some embodiments may further comprise a releasable mechanical fastener (not shown) for further ensuring a secured attachment of the funnel 200 to the base portion work area 110, even during use when all mechanisms are rotating and producing vibrations that might otherwise dislodge the connection arm 220. Such fasteners may comprise but are not limited to lock pins, threaded connectors, snap fits, clamps and latches that couple the base portion work area 110 and the connection arm 220. Other embodiments may comprise permanent fastening means, such as welds or epoxy adhesive, for permanently coupling the connection arm 220 to the base portion work area 110.

In addition to comprising a connection arm 220 that maintains the funnel 200 in an upright position, some embodiments of the funnel 200 may further comprise a stabilizing latch 230 for better maintaining the position of the funnel 200 without requiring the addition of a second connection arm 220. Having only one connection arm 220 enables a more open base portion work area 110. The addition of a stabilizing latch 230 serves to reinforce the secured attachment of the funnel 200 to the pipe threading machine 100. In the embodiment of FIGS. 2 through 6, the stabilizing latch 230 extends horizontally from the upper rim 210 of the body portion 250 for engaging a horizontal member of the base portion work area 110. The free end 232 of the stabilizing latch 230 curves downward for latching onto a front handle 125 of a horizontal support surface of the base portion work area 110, as depicted in FIG. 3. In other embodiments, the stabilizing latch 230 may be angled from horizontal. This may be useful when the connection arm 220 is also angled from horizontal. In such a case, the stabilizing latch 230 may be angled in the same direction or in a direction opposite the angle of the connection arm 220. Selecting the angle of the stabilizing latch 230 depends on attachment location of the stabilizing latch 230 to the body portion 205 or rim 210 and a need for applying a resistance force to balance forces applied by an angled connection arm 220. Selecting an appropriate angle of the stabilizing latch 230 thus ensures a secured attachment of the funnel 200 to the base portion work area 110. Additionally, the stabilizing latch 230 may be permanently affixed to the rim 210 and/or base portion work area 110 by a permanent means of fixation such as but not limited to welding and/or epoxying, or the stabilizing latch 230 may be semi permanently or releasably attached by a fixation means such as but not limited to screws, lock pins or clamps. In embodiments of the funnel 200 comprising releasable attachment means for securing the stabilizing latch 230, a machine operator may adjust the position of the stabilizing latch 230 along the rim 210 and/or body portion 205 or swap out the stabilizing latch 230 with one of greater or lesser width or length that is better sized for engaging a particular feature on the base portion work area 110 to which the stabilizing latch 230 attaches.

In addition to sloped sidewalls 207, a connection arm 220 and optional stabilizing latch 230, the funnel 200 comprises a drain pipe 225 extending from the drain hole 215. The drain pipe 225 redirects fluid draining from the base portion work area 110 into the oiler 205 or other fluid receptacle. In some embodiments, the drain pipe 225 extends substantially vertically from the drain hole 215, and in other embodiments, the drain pipe 225 may extend from the drain hole 215 at an angle. In yet other embodiments, the drain pipe 225 may be curved. These angled and curved embodiments of the drain pipe 225 may be particularly useful in instances when the ground surface directly beneath the funnel 200 prevents secure and/or level placement of oiler 105 or other fluid receptacle. By angling the trajectory of fluid and/or debris dispensed from the funnel 200 via the angled drain pipe 225, a user may place the oiler 105 or other fluid receptacle some distance away from the base portion work area 110 and nevertheless successfully entrap and recapture the jettisoned materials.

The drain pipe 225 attaches to the body portion 205 at the drain hole 215 by a permanent or semi-permanent, leak proof fixation means. In the embodiment of FIGS. 2 through 6, the drain pipe 225 attaches to the body portion 205 by a leak proof, permanent weld. In other embodiments, the drain pipe 225 may be press fit into the drain hole 215 and sealed by an oil-resistant rubber or silicon O-ring disposed about the inner circumference of the drain hole 215. Semi-permanent attachment of the drain pipe 225 to the body portion may be desirable for interchanging drain pipes 225 of varying lengths and curvatures to compensate for any variations in flooring beneath the pipe threading machine 100 and the oiler 105 or other fluid receptacle. Alternatively, some embodiments of the funnel 200 may incorporate a permanently affixed drain pipe 225 that telescopes to achieve variable lengths or bends to achieve certain trajectories of recaptured fluid and debris.

In one embodiment, the fluid receptacle into which the funnel 200 directs reusable oil or fluid emanating from the base portion work area 110 is a flask (not show) into which the drain pipe 225 extends. In one embodiment, the flask comprises a neck portion and a storage portion with at least one angled sidewall that angles the storage portion relative to a support surface. In one embodiment, the flask may have a storage portion comprising a sidewall angled at 30 degrees from vertical so that the flask rests securely at an angle when rested on the ground beneath the funnel 200. Such an angle enables the recaptured fluid to enter the flask through the neck portion and then pool in one area inside the storage portion. This improved pooling increases fluid depth and thereby facilitates recirculation by a submerged pump or dip tube disposed therein. In one embodiment, the flask has a wide mouth at the top of the neck portion for enabling a machine operator to add more fluid from a separate decanter for recirculation by the submerged pump or dip tube. In yet another embodiment, the flask may be adapted for secured, leak proof attachment directly to the bottom end of the drain pipe 225. Secured attachment means may be threaded mating portions, press fit, snap fit and any other leak proof connection means. In this embodiment, the flask may further comprise a leak proof outlet for connecting a dip tube that recirculates the reusable fluid to the base portion work area 110. The leak proof outlet may be positioned within the wall of the neck portion and/or storage portion so that the dip tube or pump may readily access the contents of the flask.

In all embodiments, the funnel 200 and all of its components preferably are manufactured from a durable, lightweight, leak proof material. For example, the material of manufacture may be any number of easily manufactured substances such as but not limited to aluminum, steel, chromoly, resin impregnated fiberglass, glass, plastic and rubber. The funnel 200 may be molded, blown or formed from a continuous sheet of fabric, plastic, rubber, or metal. Alternatively, the funnel 200 may be formed from separate metal components welded together to form a leak proof structure. As described above, in other embodiments, the sloped sidewalls 207 may be hingedly attached for collapsing the funnel 200 for compact storage when not in use. Alternatively, the body portion 205 may comprise of a collapsible wire frame covered by a supple, foldable fabric material coated with a leak proof or fluid resistant substance, such as GORE TEX or SCOTCH GUARD. Such a wire framed embodiment of the funnel 200 folds like a cloth covered lawn chair comprised of a fabric covered, hinged frame and easily enables compact storage.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; Rather, the present invention extends to all functionally equivalent structures, methods and uses, such as are within the scope of the appended claims.

I claim:

1) A pipe threading machine, comprising:
a) a base portion comprising a cutting device, a reaming device and a threading device; and
b) a funnel adapted for attaching to at least the base portion, comprising:
i. a body portion comprising one or more angled sidewalls joined to form a leak proof funnel shaped receptacle, a continuous upper rim disposed about the upper opening of the leak proof funnel shaped receptacle, and a drain hole located at the bottom of the one or more angled sidewalls;
ii. a connection arm extending from the the funnel and adapted for mating with the pipe threading machine such that the leak proof funnel shaped receptacle suspends upright; and
iii. a drain pipe extending from the drain hole for redirecting fluid draining from the base portion into a fluid repository.

2) The pipe threading machine of claim 1 wherein the funnel is detachable from the base portion.

3) The pipe threading machine of claim 1 wherein the connection arm is permanently affixed to the base portion.

4) The pipe threading machine of claim 1 wherein the connection arm extends horizontally from the funnel.

5) The pipe threading machine of claim 1 wherein the connection arm extends from the funnel at an angle from horizontal.

6) The pipe threading machine of claim 1 wherein the connection arm extends from the upper rim.

7) The pipe threading machine of claim 1 wherein the connection arm extends from the body portion.

8) The pipe threading machine of claim 1 wherein the drain pipe extends substantially vertically from the body portion.

9) The pipe threading machine of claim 1 wherein the connection arm extends horizontally from the upper rim and the drain pipe extends substantially vertically from the drain hole.

10) The pipe threading machine of claim 1 wherein the drain pipe extends from the body portion at an angle from vertical.

11) The pipe threading machine of claim 1 wherein the leak proof funnel shaped receptacle comprises four angled sidewalls.

12) The pipe threading machine of claim 1 wherein the leak proof funnel shaped receptacle comprises a single, continuous angled sidewall shaped to form a tapered cone.

13) The pipe threading machine of claim 1, further comprising a stabilizing latch extending from the upper rim and oriented for engaging a support surface of the base portion.

14) The pipe threading machine of claim 13 wherein the stabilizing latch is permanently affixed to the upper rim.

15) The pipe threading machine of claim 13 wherein the stabilizing latch is releasably clamped to the upper rim for optional attachment.

16) The pipe threading machine of claim 13 wherein the stabilizing latch attaches to the funnel at an angle.

17) The pipe threading machine of claim 1 wherein drain pipe is telescoping for achieving a variable length.

18) The pipe threading machine of claim 1 wherein the one or more angled sidewalls are angled between 30 and 45 degrees.

19) The pipe threading machine of claim 1, further comprising a non-stick coating on the one or more angled sidewalls.

20) The pipe threading machine of claim 1, further comprising a support element for connecting the connection arm to the upper rim.

21) The pipe threading machine of claim 1 wherein the connection arm is a pipe adapted for fitted insertion within a hollow pipe receptacle on the pipe threading machine

22) The pipe threading machine of claim 21 wherein the connection arm is secured to the hollow pipe receptacle by a releasable mechanical fastener.

23) The pipe threading machine of claim 22 wherein the releasable mechanical fastener is selected from the group consisting of lock pins, threaded connectors, snap fits, clamps and latches.

24) The pipe threading machine of claim 1 wherein the detachable funnel is manufactured from a lightweight and durable material.

25) The pipe threading machine of claim 24 wherein the lightweight durable material is selected from a group consisting of aluminum, sheet steel, chromoly, fiber glass, fiberglass resin, glass, plastic, and rubber.

26) The pipe threading machine of claim 1, wherein the detachable funnel is collapsible.

27) The pipe threading machine of claim 1 wherein the drain pipe is releasably attached to the body portion by a leak proof seal.

28) The pipe threading machine of claim 1 wherein the drain pipe is welded to the body portion.

29) The pipe threading machine of claim 1 wherein the fluid repository is an oiler bucket.

30) The pipe threading machine of claim 1 wherein the fluid repository is an angled bottom flask adapted for secure connection to a free end of the drain pipe.

31) The pipe threading machine of claim 30, further comprising a dip tube having one end adapted for insertion into the flask and a free end adapted for recirculating oil from the flask to the base portion.

32) A method of manufacturing a pipe threading machine comprising:
a) assembling a base portion comprising a threader, a cutter and a reamer;
b) attaching a funnel to the base portion beneath the threader, cutter, and reamer, wherein the funnel comprises:
i. a body portion comprising one or more angled sidewalls that form a leak proof funnel shaped receptacle, a continuous upper rim disposed about the upper opening of the leak proof funnel shaped receptacle, and a drain hole located at the bottom of the one or more angled sidewalls;
ii. a connection arm extending from the funnel wherein the connection arm is adapted for mating with the base portion and suspending the leak proof funnel shaped receptacle in an upright position; and
iii. a drain pipe extending from the drain hole for redirecting fluid draining from the base portion into a fluid repository.

33) The method of claim 32 wherein the funnel is detachable from the base portion.

34) The method of claim 32 wherein the connection arm is permanently affixed to the base portion.
